(19) United States
(12) Patent Application Publication
(10) Pub. No.: US 2026/0006095 A1
(43) Pub. Date: Jan. 1, 2026

(54) CIRCUIT BREAKER CHECK FUNCTION FOR OATP TEST AND AIRCRAFT

(71) Applicant: Hamilton Sundstrand Corporation, Charlotte, NC (US)

(72) Inventors: Lijun Qian, Byron, IL (US); Joshua C. Swenson, Rockford, IL (US)

(21) Appl. No.: 18/758,769

(22) Filed: Jun. 28, 2024

(51) Int. Cl. H04L 67/12; H04L 12/40; H04L 67/125

(52) U.S. Cl. CPC H04L 67/12; H04L 12/40013; H04L 67/125

(57) ABSTRACT

A method includes receiving, by an electronic device via a data bus, status information associated with a set of circuit breakers (CBs) of the aircraft. The status information includes an identifier and current state of each among the set. The method includes obtaining a database including on aircraft test procedure (OATP) CB tables in a second data format and including the CB identifier and an expected state of each CB among the set. The method includes translating the status information from a first data format to the second data format, thereby generating a translated current state of each CB among the set. The method includes, for each respective CB among the set, determining whether the translated current state and the expected state conflict and in response to identifying a conflict between the expected state and the translated current state, generating a command to change the current state.

### TECHNICAL FIELD

This disclosure relates generally to power system maintenance of aircraft. More specifically, this disclosure relates to a circuit breaker check function for on aircraft test procedure (OATP) test and aircraft.

### BACKGROUND

Many aircraft subsystems or equipment need to be powered and tested during the On Aircraft Test Procedure (OATP) phase. Each Air Transport Association of America (ATA) test requires different presets for the circuit breakers (CBs) of the aircraft power system. Therefore, manual inspection of nearly a thousand (1,000) CBs for a typical middle size commercial aircraft will be performed using the onboard CB indication and control (CBIC) user interface displayed through the cockpit display. It is time-consuming process that usually, takes about 3-4 hours to visually observe (e.g., check) the closed/open switch position of approximately 1000 or more CBs to observe any conflict with an expected state displayed on the CBIC user interface.

### SUMMARY

This disclosure relates to a circuit breaker check function for on aircraft test procedure (OATP) test and aircraft.

In some examples, a method includes receiving, by a first electronic device via a data bus, status information associated with a set of circuit breakers (CBs) of an aircraft. The status information is in a first data format. The status information includes a CB identifier and a current state of each circuit breaker (CB) among the set of CBs. The method includes obtaining, by the first electronic device, a database that includes on aircraft test procedure (OATP) CB tables in a second data format. The OATP CB tables include the CB identifier and an expected state of each CB among the set of CBs. The method includes translating the status information from the first data format to the second data format, thereby generating a translated current state of each CB among the set of CBs. The method includes, for each respective CB among the set of CBs, determining whether the translated current state and the expected state conflict. The method includes, for each respective CB among the set of CBs, in response to identifying a conflict between the expected state and the translated current state, generating a command to change the current state of the respective CB.

Any single one or any combination of the following features may be used with the examples. In the method, generating the command to change the current state of the respective CB further comprises automatically changing the current state of the respective CB to match the expected state of the of the respective CB. In the method, generating the command to change the current state of the respective CB further comprises receiving user input via a user interface to change the current state of the respective CB to match the expected state of the of the respective CB. In the method, the user input includes a one-click selection to correct all of the conflicts identified among the set of CBs; and the method further comprises generating the command to change the current state of each conflicted CB for which the conflict was identified between the expected state and the translated current state. In the method, the user input includes a one-by-one selection to correct the conflict identified between the expected state and the translated current state of a conflicted CB selected by the user input; and the method further comprises generating the command to change the current state of the selected conflicted CB for which the conflict was identified. The method includes connecting the first electronic device to a power distribution system of the aircraft via the data bus, wherein the power distribution system is connected to the set of CBs and generates the status information; receiving the status information from the power distribution system connected to the data bus; obtaining the database by retrieving the database from a memory of the first electronic device; and transmitting the command to one or more conflicted CBs, among the set of CBs, for which the conflict was identified between the expected state and the translated current state. In the method, the first electronic device includes a power distribution system of the aircraft; and the method further comprises: obtaining the database further comprises retrieving the database from an onboard maintenance server (OMS) of the aircraft; and transmitting the command to a circuit breaker indication and control system of the aircraft. In the method, the first data format includes an ARINC data format specified by Airlines Electronic Engineering Committee (AEEC); and the second data format includes a human-readable data format.

In other examples, an electronic device includes a processor configured to: receive, via a data bus, status information associated with a set of circuit breakers (CBs) of an aircraft, the status information in a first data format and including a CB identifier and a current state of each circuit breaker (CB) among the set of CBs. The processor is configured to obtain a database that includes on aircraft test procedure (OATP) CB tables in a second data format. The OATP CB tables include the CB identifier and an expected state of each CB among the set of CBs. The processor is configured to translate the status information from the first data format to the second data format, thereby generating a translated current state of each CB among the set of CBs. The processor is configured to, for each respective CB among the set of CBs, determine whether the translated current state and the expected state conflict and in response to identifying a conflict between the expected state and the translated current state, generating a command to change the current state of the respective CB.

Any single one or any combination of the following features may be used with the examples. Within the electronic device, to generate the command to change the current state of the respective CB, the processor is further configured to automatically change the current state of the respective CB to match the expected state of the of the respective CB. Within the electronic device, to generate the command to change the current state of the respective CB, the processor is further configured to receive user input via a user interface to change the current state of the respective CB to match the expected state of the of the respective CB. Within the electronic device, the user input includes a one-click selection to correct all of the conflicts identified among the set of CBs; and the processor is further configured to generate the command to change the current state of each conflicted CB for which the conflict was identified between the expected state and the translated current state. Within the electronic device, the user input includes a one-by-one selection to correct the conflict identified between the expected state and the translated current state of a conflicted CB selected by the user input; and the processor is further configured to generate the command to change the current state of the selected conflicted CB for which the conflict was identified. Within the electronic device, the processor is further configured to: connect the electronic device to a power distribution system of the aircraft via the data bus, wherein the power distribution system is connected to the set of CBs and generates the status information; receive the status information from the power distribution system connected to the data bus; obtain the database by retrieving the database from a memory of the electronic device; and transmit the command to one or more conflicted CBs, among the set of CBs, for which the conflict was identified between the expected state and the translated current state. The electronic device further includes a power distribution system of the aircraft, wherein: to obtain the database, the processor is further configured to retrieve the database from an onboard maintenance server (OMS) of the aircraft; and the processor is further configured to transmit the command to a circuit breaker indication and control system of the aircraft. Within the electronic device, the first data format includes an ARINC data format specified by Airlines Electronic Engineering Committee (AEEC); and the second data format includes a human-readable data format.

A non-transitory computer readable medium comprising program code is provided. The computer program includes computer readable program code that when executed causes a processor of an electronic device to receive, via a data bus, status information associated with a set of circuit breakers (CBs) of an aircraft. The status information in a first data format and includes a CB identifier and a current state of each circuit breaker (CB) among the set of CBs. The computer readable program code causes the processor to obtain a database that includes on aircraft test procedure (OATP) CB tables in a second data format and including the CB identifier and an expected state of each CB among the set of CBs. The computer readable program code causes the processor to translate the status information from the first data format to the second data format, thereby generating a translated current state of each CB among the set of CBs. For each respective CB among the set of CBs, the computer readable program code causes the processor to determine whether the translated current state and the expected state conflict and in response to identifying a conflict between the expected state and the translated current state, generating a command to change the current state of the respective CB.

Any single one or any combination of the following features may be used with the examples. To generate the command to change the current state of the respective CB, the computer readable program code causes the processor to receive user input via a user interface to change the current state of the respective CB to match the expected state of the of the respective CB. The computer readable program code causes the processor to connect the electronic device to a power distribution system of the aircraft via the data bus, wherein the power distribution system is connected to the set of CBs and generates the status information. The computer readable program code causes the processor to receive the status information from the power distribution system connected to the data bus. The computer readable program code causes the processor to obtain the database by retrieving the database from a memory of the electronic device. The computer readable program code causes the processor to transmit the command to one or more conflicted CBs, among the set of CBs, for which the conflict was identified between the expected state and the translated current state. In some examples, the electronic device includes a power distribution system (PDS) of the aircraft; and the computer readable program code causes the processor to: obtain the database further comprises retrieving the database from an onboard maintenance server (OMS) of the aircraft; and transmit the command to a circuit breaker indication and control system of the aircraft.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates a circuit breaker maintenance and control system in which an electronic device executes a circuit breaker check function (CBCF) and controls a state of circuit breakers via a data bus connection to a remote power distribution system, according to embodiments of this disclosure;

FIG. 2 illustrates an onboard aircraft computer system in which a power distribution system executes a circuit breaker check function (CBCF) and includes a CB display controller for controlling a flight deck display associated with a CB indication and control (CBIC), according to embodiments of this disclosure;

FIG. 3 illustrates a graphical user interface (GUI) of a circuit breaker status display according to embodiments of this disclosure;

FIG. 4 illustrates an example computing device or system supporting a circuit breaker check function for on-aircraft test procedure (OATP) test according to this disclosure; and

FIG. 5 illustrates a method for executing a circuit breaker check function for on-aircraft test procedure (OATP) test and aircraft, according to embodiments of this disclosure.

### DETAILED DESCRIPTION

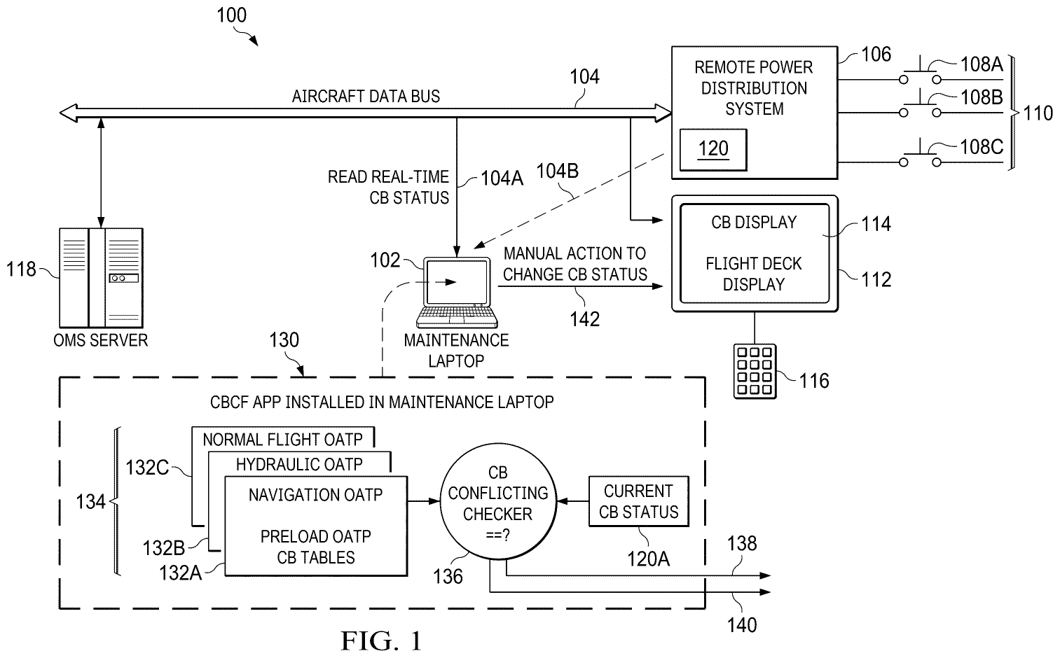

FIGS. 1 through 5, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

FIG. 1 illustrates a system 100 in which an electronic device 102 executes a circuit breaker check function (CBCF) and controls a state of circuit breakers via a data bus connection to a remote power distribution system, according to embodiments of this disclosure. The embodiment of the system 100 shown in FIG. 1 is for illustration only, and other embodiments could be used without departing from the scope of this disclosure.

The system 100 includes the electronic device 102 and components of an aircraft, including an aircraft data bus 104, remote power distribution system 106, one or more circuit breakers 108a-108c (generally circuit breaker 108) that together form a set 110 of circuit breakers, a flight deck display 112 that is associated with a CB indication and control (CBIC) and that displays a user interface 114 associated with the set 110 of circuit breakers, a keypad 116 that can change the state (such as switch position) of a circuit breaker 108, and onboard maintenance server (OMS) 118 of the aircraft. The circuit breaker 108 can be a Solid-State Circuit breaker (SSPC) that is controlled electrically or a Thermo circuit breaker (TCB) that is controlled manually.

The data bus 104 connects to other components of the aircraft, enabling those other components to establish communication channel among each other. For example, communication interfaces of the OMS server 118 and of the remote power distribution system 106 connect to the data bus 104, respectively, enabling bidirectional communication. As another example, the data bus 104 can include an available connection interface 104a configured to connect to a communication interface of the electronic device 102. For example, the available connection interface 104a could be a different type (or same type or adapter to the same time) of connection interface than other connection interfaces of data bus 104 that connect to the other components of the aircraft, as the available connection interface 104a is configured to connect to an external electronic device 102 that is not a component of the aircraft. During a period of schedule maintenance for the aircraft, the external electronic device 102 connects to the available connection interface 104a.

The remote power distribution system 106 generates machine-readable, structured data. The remote power distribution system 106 includes a machine-readable medium or computer-readable medium (such as storage) configured to store data in a format easily readable by a machine such as digital computer. Particularly, the power distribution system 106 is connected to the set 110 of CBs and generates status information 120. For example, the power distribution system 106 monitors the OPEN/CLOSED switch position of each CB 108 among the set 110 of CBs at the current time, and stores a status information 120 including the real-time CB state corresponding to the switch position at the current time. The status information 120 is stored, for example, in the form of a computer-readable look up table (LUT)) that can include a CB identifier (such as a name) unique to each CB among the set 110 of CBs, and updates the LUT in real-time to include a current state corresponding to the switch position at the current time. That is, the OPEN switch position corresponds the OUT state in which the respective CB is out-of-service and not carrying electric power to the other components of the aircraft. Oppositely, the CLOSED switch position corresponds the IN state in which the respective CB is in-service and carrying electric power to the other components of the aircraft. The remote power distribution system 106, using the CBIC, communicates with the flight deck display 112 to display the status information 120. The status information 120 can be accessed by, for example, read by a processing device of the electronic device 102 while connected to the data bus 104 via the available connection interface 104a. In some embodiments, a transmission 104b from the power distribution system 106 to the electronic device 102 conveys the status information 120, for example, via the data bus 104.

The keypad 116 can be a hardware component located in the cockpit and coupled to the flight deck display 112, or can be displayed within the user interface 114. The keypad 116 can receive user input to update a switch position of a selected CB among the set 110. Updating the switch position can include changing the OPEN/CLOSED switch position from a current switch position to the other switch position, or can include maintaining the current switch position. The keypad 116 can send received user input (for example, converted into the form a command) to the remote power distribution system 106, which generates control signals to update the switch position of the CB selected according to the user input. That is, the keypad 116 can generate a command, similar to the user-interactive command 142, to be sent to the remote power distribution system 106 for changing the state of a selected CB 108.

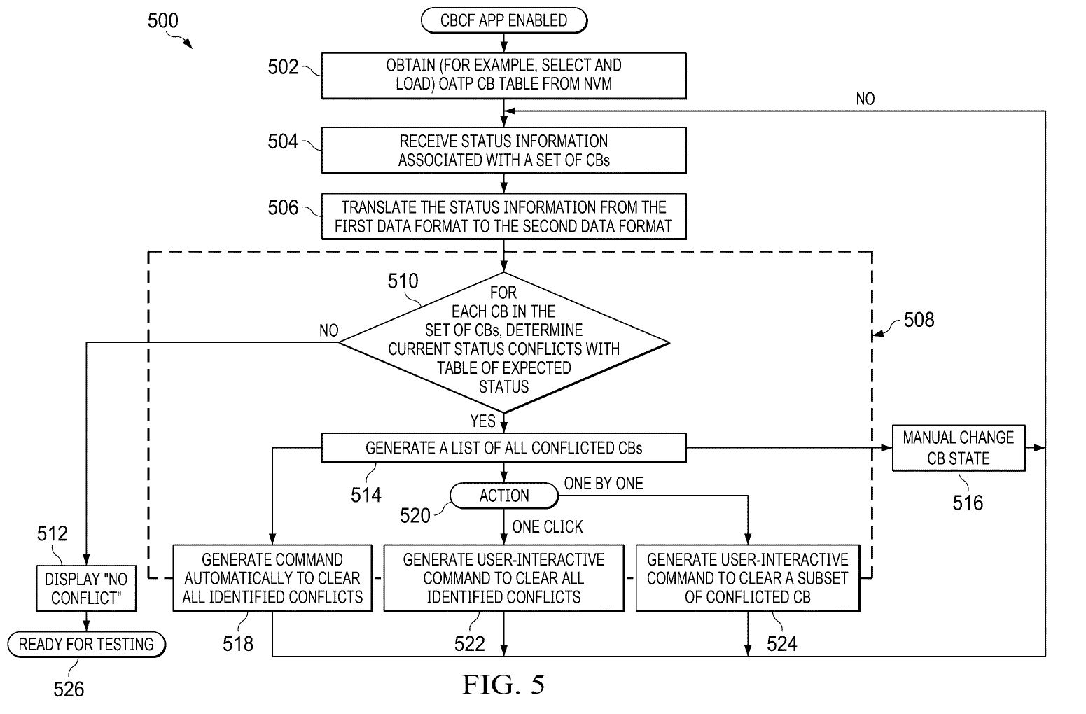

The system 100 includes a CBCF application 130 that the electronic device 102 stores and executes, according to a first embodiment of this disclosure (illustrated as Approach 1 in FIG. 5). The CBCF application 130 is more simply referred to herein as “CBCF app” or as “CBCF.” The electronic device 102 can be a laptop computer registered to or belonging to a user, such as a maintenance technician, authorized to communicate via the data bus 104 of the aircraft. An owner or manufacturer of the aircraft can provide authorization to connect to the data bus 104 via the CBCF app 130. For example, user credentials may be required to enable the CBCF app 130 to run on the electronic device 102.

The CBCF application 130 enables the electronic device 102 to perform functions described further in this disclosure, however, for ease of explanation, these functions of this disclosure are described as performed by the CBCF app 130. The CBCF app 130 stores at least one OATP preset CB table 132 that is in a human-readable data format and is initially preloaded in a memory of the electronic device 102. The at least one OATP preset CB table 132 can include one table or any number of multiple tables. The OATP preset CB table 132 includes a unique CB identifier and an expected state of each CB among the set 110 of CBs. In some embodiments, the CBCF app 130 stores a database 134 formed from the at least one OATP preset CB table 132. The at least one OATP preset CB table 132, for example, includes preloaded OATP CB tables 132a, 132b, and 132c corresponding to the aircraft's navigation system, hydraulic system, and normal flight system, respectively. The at least one OATP preset CB table 132, can include one or more preloaded OATP CB tables corresponding to any other aircraft system from among the aircraft's multiple systems.

The CBCF app 130 establishes communication with the remote power distribution system 106 and with the flight deck display 112 via a connection to the data bus 104. The CBCF app 130 receives (for example, downloads) status information 120 from the remote power distribution system 106 via the data bus 104, and can store a copy of the received status information 120a. The copy of the received status information 120a can be stored as-is, in the first data format (namely, a computer-readable data format), or can be stored post-translation in a second data format (namely, a human-readable data format). That is, the CBCF app 130 is able to translate the received status information 120 from a computer-readable first data format to a human-readable second data format.

The CBCF app 130 includes a CB conflict checker 136 (for example, a CB conflict checker module) that compares current CB state against an expected CB state that is the state required by the OATP CB table 132. The CBCF app 130 generates a list 138 all conflicted CBs for which a conflict was identified between the expected CB state and the current state. Particularly, in response to the CB conflict checker 136 determining that the current state of a respective CB, from among the set 110 of CBs, does not correspond to (such as does not match) the expected CB state, the CBCF app 130 adds the unique identifier of the respective CB to the list 138 of conflicted CBs to be corrected. The list 138 can also include the expected CB states in relation to the corresponding identifiers of the conflicted CBS, respectively. In some embodiments, the CBCF app 130 outputs list 138 using an output device associated with the electronic device 102, such as a laptop screen, or printer connected to the. electronic device 102. The list 138 defines a subset of the set 110 of CBs associated with conflicts to be corrected. The list 138 notifies the user of the electronic device 102 of which CBs to apply a change to the OPEN/CLOSED switch position.

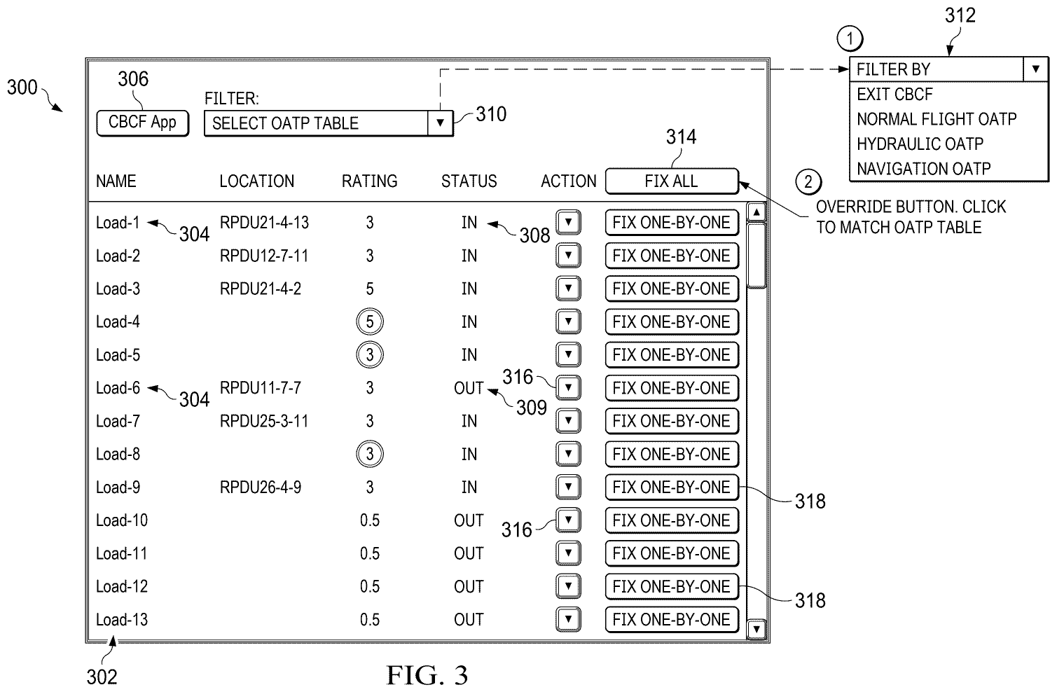

The remote power distribution system 106 electrically clears (removes or corrects) a conflict identified by the CB conflict checker 136 by executing a command that is automatically-generated or a command that is generated in response to a user input. Particularly, the CBCF app 130 can automatically-generate a command 140 to change the state of each conflicted CB within the list 138, and send the automatic command 140 to the remote power distribution system 106 (via the aircraft data bus 104) based on the list 138. Alternatively, the CBCF app 130 can output a graphical user interface (GUI) (for example, FUI 300 of FIG. 3 described further below), generate a user-interactive command 142 in response to receiving user input (through the GUI 300) indicating the user's desired selection to clear one or more conflicts, and send the user-interactive command 142 to the remote power distribution system 106 based the CB(s) selected by the user. The CBCF app 130 displays the GUI 300 via an output device, such as the screen of the laptop computer. Although not shown in FIG. 1, the remote power distribution system 106 receives the command (namely, the automatic command 140 or the user-interactive command 142) from the CBCF app 130 via the data bus 104. The CBCF app 130 generates and configures the command 140,142 to cause the remote power distribution system 106 to update (for example, change) the state of conflicted CBs from the current stat to the expected state in response to receipt of the command 140, 142.

This disclosure is not limited to aircraft that include a remote power distribution system 106, which electrically controls of the set 110 of CBs. In some embodiments, the set 110 of CBs are manually controlled by a mechanical or thermal circuit breaker (also referred to as Thermo circuit breaker (TCB)). For example, the set 110 of CBs can include manually-operated actuators for controlling the OPEN/CLOSED switch position in addition to the power distribution system 106. In a case in which the maintenance technician is authorized to view the status information 120 and is not authorized to send a command to the remote power distribution system 106 for updating a switch position of a selected CB, then the maintenance technician may be able to manually operate the mechanical or thermal circuit breaker according to a list of conflicted CBs. For example, the maintenance technician reads the list 138 and makes manual changes either to SSPCs via flight deck display 112 (for example, user input to the keypad 116 associated with the user interface 114) or to TCBs via physically pushing/pulling the TCBs. The list of conflicted CBs saves time by not requiring the maintenance technician from visually inspecting the current state of the entire set 110 of CBs. In a case in which the owner of the aircraft opts to only permit unidirectional communication from the aircraft data bus 104 to the external electronic device 102, thereby denying the external electronic device 102 from sending a command for electrically controlling of the set 110 of CBs, then the list of conflicted CBs saves time by enabling the maintenance technician to manually operate mechanical or thermal circuit breaker of only conflicted CBs, less than the entire set 110 of CBs.

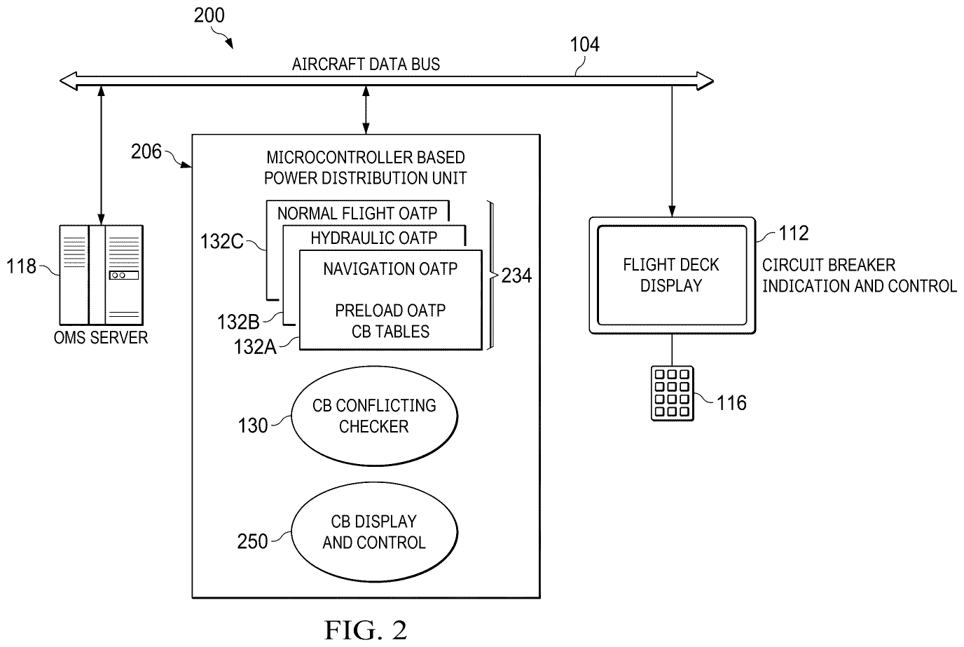

FIG. 2 illustrates an onboard aircraft computer system 200 in which a power distribution system 206 executes a circuit breaker check function (CBCF) and includes a CB display controller 250 for controlling a flight deck display 112 associated with a CB indication and control (CBIC), according to embodiments of this disclosure. The embodiment of the system 200 shown in FIG. 2 is for illustration only, and other embodiments could be used without departing from the scope of this disclosure. The data bus 104, flight deck display 112 that displays a user interface associated with the set of circuit breakers coupled to the remote power distribution system, and OMS 118 can be the same as shown in FIG. 1. For simplicity, the CB display controller 250 is included in the CBIC and referred to as CBIC 250, and can be included in and operates in a same or similar manner within the remote power distribution system 106 of FIG. 1.

In the system 200, the remote power distribution system 206 stores and executes the CBCF app 130, thereby eliminating a connection between an external electronic device 102 and the aircraft data bus 104. The remote power distribution system 206 in the system 200 of FIG. 2 can be the same as the corresponding component 106 in the system 100 of FIG. 1. The remote power distribution system 206 includes one or more processing devices (such as a microprocessor) configured to execute the CBCF app 130 and to control other functions of the remote power distribution system 206, for example, other functions associated with the CBIC 250. The OATP CB tables 132a-132c as shown in FIG. 1 are initially preloaded in a storage of the OMS 118, forming the database 234 of FIG. 2, which can operate in a same or similar manner as the corresponding database 134 of FIG. 1. However, the OMS 118 is able to transmit the database 234 to the remote power distribution system 206, and thereby enable the CBCF app 130 to access the database 234 stored in the remote power distribution system 206. Instead of downloading the entire database 234, the CBCF app 130 is able to download a user-selected OATP CB table 132 from among multiple tables in the database 234 stored in the OMS 118, in response to receiving receive user input (such as user input via GUI 300 shown in FIG. 3) selecting which test procedure will be performed. For example, if the user selects an OATP related to the navigation system of the aircraft, then the CBCF app 130 selects and downloads the OATP CB table 132A corresponding to the aircrafts navigation system.

The CBIC 250 receives command 140, 142 generated by the CBCF app 130, and in response, updates the state of one or more conflicted CBs 108 connected to the remote power distribution system 206. In response to receiving the command 140, 142, the CBIC 250 is able to generate a corresponding control signal to actuate conflicted CB to change the OPEN/CLOSE switch position to correspond to the expected state.

Additionally, CBIC 250 controls the flight deck display 112. For example, CBCF app 130 can generate and send the GUI 300 (FIG. 3) to the CBIC 250, which controls the flight deck display 112 to display the GUI 300 received from the CBCF app 130.

Although FIG. 2 illustrates on example an onboard aircraft computer system 200 in which a power distribution system 206 executes the CBCF app 130, various changes can be made to FIG. 2. For example, the CBCF app 130 can be referred to as embedded into the CBIC 250 that controls the flight deck display 112 to display the GUI 300 of FIG. 3. As another example, the CBIC 250 can display the list 138, received from the CBCF app 130, on the flight deck display 112, for example, as shown in the GUI 300 of FIG. 3.

FIG. 3 illustrates a graphical user interface (GUI) 300 of a circuit breaker status display according to embodiments of this disclosure. FIG. 3 shows the GUI 300 together with first and second drop-down menus. FIG. 3 shows the GUI 300 enlarged to be legible. The embodiment of the GUI 300 shown in FIG. 3 is for illustration only, and other embodiments could be used without departing from the scope of this disclosure.

The GUI 300 can include a list 302 of identifiers of CBs in a first column, a location of the CBs in a second column, following by columns for a rating, a status, and an action. More particularly, the list 302 is a display of the list 138 of conflicted CBs of FIG. 1. The list 302 of identifiers of the CBs includes unique names 304 for each CB. The GUI 300 can include a first button 306 (illustrated as “CBCF App” button) that if selected (for example, clicked by a user), then the CBCF app 130 executes the conflict checker 136. More generally, the user can click the first button 306 in order to enter into a CBCF mode. For example, the name 304 of a CB (such as “Load-1” can be the name of a load served through or protected by that CB. As a visual indicator of no-conflict, the list 302 identifiers of conflicted CBs is empty when the current state and expected state match for all CBs associated with the selected OATP table 132. Oppositely, the name 304 (or presence) of each conflicted CB displayed in the list 302 functions as a visual indicator of conflict associated with that CB.

In the Status column, the current status of the CBs is shown, respectively. The “IN” status 308 indicates that the switch position of the CB is the CLOSED and that the CB is in service. Oppositely, the “OUT” status 309 indicates that the switch position of the CB is the OPEN and that the CB is out-of-service.

The GUI 300 can include a filter button 310 that enables the user to select filtering criterion for filtering the list 302 of identifiers. When the filter button 310 (illustrated as “Select OATP Table”) is selected, a drop-down menu 312 shows a list of filtering criteria: Exit CBCF, CBs for Normal Flight OATP, CBs for Hydraulic OATP, and CBs for Navigation OATP. The drop-down menu 312 can include other filtering criterion (not shown), such as: CBs for Landing Gear OATP, and ALL. If “ALL” is selected, then the list 302 displayed can include a list of the entire set 110 of CB, instead of displaying the list 138 of conflicted CBs. If “Hydraulic OATP” is selected as the filtering criterion, then the CBCF app 130 compares the current state of the set 110 of CBs to the expected states in the OATP table 132b related to the aircraft's hydraulic system. More generally, to select an OATP table 132 from the database 134, 234, the user can click or select the table name from the drop-down menu 312.

The GUI 300 can include a “FIX ALL” button 314 that enables the user to update all conflicted CBs to the expected states of the selected OATP table 132. As an example, the state of the SSPC type of CB 108 can be changed by one-click on the “FIX ALL” button 314.

In the Action column, the GUI 300 can include a select-for-action button 316 located in relation to an action button 318 (illustrated as “FIX ONE-BY-ONE”) for each conflicted CB. The select-for-action button 316 enables the user to select one or more conflicted CBs for inclusion within a subset of selected conflicted CBs. If the action button 318 is clicked while the subset includes one or more conflicted CBs based on the select-for-action button 316 having been clicked, then the subset of is empty, such as when no select-for-action button 316 has been clicked, then the CBCF app 130 will generate a command 142 to change the subset of selected conflicted CBs to the expected state. On the other hand, if the action button 318 is clicked while the subset is empty, then the CBCF app 130 will generate a command 142 to change the one conflicted CB that corresponds to the action button 318 clicked. By selecting the action button 318 (for example, using CBIC 250 tool in the flight deck display 112), the CB state can be changed to match with the expected state set forth in the selected OATP CB table, one-by-one. One-by-one refers to the action button 318 causing the CBCF app 130 to generate a command 142 to change one (or a subset of) selected conflicted CB, but in comparison, the “FIX ALL” button 314 causes the CBCF app 130 to generate a command 142 to change all conflicted CBs.

The CBCF function will help the aircraft manufacturing and maintenance process: significantly reduce OATP setup time, simplify the test process, reduce human errors in the test process for aircraft manufacturing. Thereby improving the quality of aircraft testing.

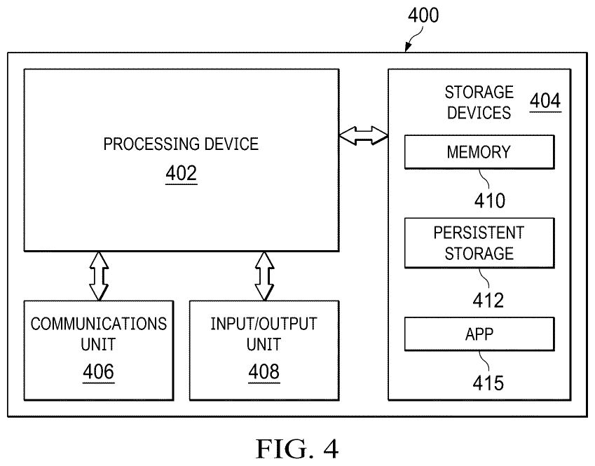

FIG. 4 illustrates an example computing device or system 400 supporting a circuit breaker check function for on-aircraft test procedure (OATP) test according to this disclosure. The computing device or system 400 may, for example, be used to implement the electronic device 102 shown in FIG. 1 and described above, or, be used to implement the power distribution system 206 shown in FIG. 2 and described above. Thus, the computing device or system 400 may be used to implement one or more functions of or related to the circuit breaker check function, and controlling a flight deck display associated with a CBIC.

As shown in FIG. 4, the computing device or system 400 may include at least one processing device 402, at least one optional storage device 404, at least one communications unit 406, and at least one optional input/output (I/O) unit 408. The processing device 402 may execute instructions that can be loaded into a memory 410 or other location that is local to the processing device 402. The processing device 402 includes any suitable number(s) and type(s) of processors or other processing devices in any suitable arrangement. Example types of processing devices 402 include one or more microprocessors, microcontrollers, digital signal processors (DSPs), ASICs, FPGAs, or discrete circuitry.

The memory 410 and a persistent storage 412 are examples of storage devices 404, which represent any structure(s) capable of storing and facilitating retrieval of information (such as data, program code, and/or other suitable information on a temporary or permanent basis). The memory 410 may represent a random access memory or any other suitable volatile or non-volatile storage device(s). The persistent storage 412 may contain one or more components or devices supporting longer-term storage of data, such as a read only memory, hard drive, Flash memory, or optical disc.

The communications unit 406 supports communications with other systems or devices. The communications unit 406 may support communications through any suitable physical or wireless communication link(s), such as a network or dedicated connection(s).

The I/O unit 408 allows for input and output of data. For example, the I/O unit 408 may provide a connection for user input through a keyboard, mouse, keypad, touchscreen, or other suitable input device. The I/O unit 408 may also send output to a display or other suitable output device. Note, however, that the I/O unit 408 may be omitted if the device or system 400 does not require local I/O, such as when the device or system 400 represents a server or other component that can be accessed remotely over a network.

Although FIG. 4 illustrates one example of a computing device or system 400 supporting a circuit breaker check function for on-aircraft test procedure (OATP) test according to this disclosure, various changes may be made to FIG. 4. For example, computing devices and systems come in a wide variety of configurations, and FIG. 4 does not limit the circuit breaker check function for on-aircraft test procedure (OATP) test to any particular computing device or system. As another example, the storage device 404 can store an application 415 that is the same as the CBCF application 130 of FIGS. 1 and 2 as described in this disclosure.

FIG. 5 illustrates a method 500 for a circuit breaker check function for on-aircraft test procedure (OATP) test and aircraft, according to embodiments of this disclosure. The method 500 of FIG. 5, is performed by the electronic device 102 of FIG. 2 when a processing device of the electronic device 102 executes the CBCF app 130, when executed by, enables to perform.

At the start of the method 500, the CBCF application 415 is enabled. For example, the processing device 402 executes (for example, runs) the CBCF application 415. At block 502, the processing device 402 of a first electronic device obtains a database 134. The database 134 includes on aircraft test procedure (OATP) CB tables 132 in a second data format. The OATP CB tables 132 include a CB identifier (such as name 304) and an expected state (which is opposite to the current state 308, 309) of each CB among the set 110 of CBs. In a first embodiment, the first electronic device can be the electronic device 102 shown in FIG. 1 that obtains the database 134 by retrieving the database from a storage device 404 of the first electronic device such as the memory 410. In a second embodiment, the first electronic device can be power distribution system 206 shown in FIG. 2 that obtains the database 134 by retrieving the database from an onboard maintenance server (OMS) 118 of the aircraft.

At block 504, the processing device 402 of the first electronic device receives, via a data bus 104 of an aircraft, status information 120 associated with a set 110 of CBs of the aircraft. The status information 120 is in a first data format. The status information 120 includes a CB identifier and a current state of each CB 108a, 108b, and 108c among the set 110 of CBs. To receive the status information 120 in the first embodiment, the electronic device 102 connects to the power distribution system 106 of the aircraft via the data bus 104 and receives the status information from the power distribution system that is connected to the data bus 104. In the second embodiment, the power distribution system 106 receives the status information 120 from the set 110 of CBs. The status information 120 is in a first data format, such as an ARINC data format that is standardized computer-readable format specified by Airlines Electronic Engineering Committee (AEEC). Generally, the ARINC data format is not human-readable.

The first data format of the status information 120 is not limited to being a computer-readable format, and in some embodiments, can be a human-readable format, or can be a data format that is similar to or comparable to the second data format of the OATP preset CB table 132. And For ease of explanation, the “translated current state” can refer to the current state the first data format of the status information 120, in this situation when the first and second data formats are similar or comparable to each other such that the expected state within the OATP preset CB table 132 can be compared to the current state within the status information 120 (or the received status information 120a) without translating the status information 120 to the second data format.

Optionally, such as when the first data format and second data format are dissimilar or not comparable, the CBCF app 130 enables the processing device 402 to perform the translation procedure of block 506. In block 506, translation of the status information 120 from the first data format to the second data format is performed, thereby generating a translated current state of each CB among the set of CBs. That is, the translated current state of a respective CB is in the second data format. The first data format is a computer-readable format, such as an ARINC data format specified by Airlines Electronic Engineering Committee (AEEC). The second data format is a human-readable format, such as a spreadsheet format with header labeling. In some embodiments, the processing device 402 of the first electronic device translates the status information 120 from the first data format to the second data format. In some embodiments, the processing device 402 of the first electronic device receives, from an external device, the status information 120 already translated from the first data format to the second data format.

Within block 508, for each respective CB among the set of CBs, the processing device 402 of the first electronic device determines whether the translated current state and the expected state conflict and in response to identifying a conflict between the expected state and the translated current state, generates a command to change the current state of the respective CB. Block 508 can include blocks 510-524.

At block 510, the processing device 402 of the first electronic device determines, for each respective CB among the set of CBs, whether the translated current state and the expected state conflict. When compared, if the translated current state corresponds to (for example, matches or is equivalent to) the expected state, the processing device 402 determines “No Conflict” exists for the respective CB, and the method 500 proceeds to block 512. Alternatively, if the translated current state does not correspond to (for example, does not match or is not equivalent to) the expected state, the processing device 402 determines that a conflict exists for the respective CB, thereby identifying a conflict associated with the respective CB. In response to identifying a conflict between the expected state and the translated current state for the respective CB, the method 500 proceeds from block 510 to block 514 in a first embodiment (as shown in FIG. 1) and in a second embodiment (as shown in FIG. 2).

At block 512, in response to a determination that no conflict is identified between the expected state and the translated current state for each respective CB among the set of CBs, the processing device 402 of the first electronic device outputs a visual indicator that indicates no conflict is associated with any among the set of. For example, the visual indicator can be displayed on the circuit breaker status display shown in the GUI 300 of FIG. 3. The method 500 ends 526 for the respective CB, as the current state of the respective CB matches the OATP table that contains the corresponding expected state, and the respective CB is ready for testing.

At block 514, in response to identifying a conflict between the expected state and the translated current state for a respective CB among the set of CBs, the processing device 402 of the first electronic device outputs a list 138 all conflicted CBs or an alert (for example, visual indicator that indicates) that the identified conflict is associated with the respective CB. The list 138 can be displayed via an output device associated with the electronic device. For example, the CBCF app 415 can cause the external electronic device 102 to display the list 138 via a screen of the laptop, or the CBCF app 415 can cause the remote power distribution system 206 to display the list 138 via the flight deck display 112. According to various embodiments of this disclosure, the list 138 can be used as tool to help remove the identified conflicts in multiple ways, including but not limited to the following ways: (1) manually; (2) electrically, in a case in which an automatic command 140 is generated in response to the identification of the conflicts among set of CBs 110; or (3) electrically, in a case in which user input causes a user-interactive command 142 to be generated.

The method proceeds to block 516 in a case in which the aircraft's data bus 104 allows only unidirectional communication and does not allow the electronic device (102 of FIG. 1) to send a command to the remote power distribution system 106. At block 516, the state of a conflicted CB is changed manually, for example by a maintenance technician physically pushing or pulling to change the switch position of the CB. After the maintenance technician has manually changed a state of a CB, the method 500 returns to block 504 to update the status information 120.

Further within block 508, the processing device 402 generates a command to change the current state of the respective CB. As shown at block 518, some embodiments clear conflict(s) automatically (without intervention from a human), generating a command to change the current state of each respective conflicted CB to match the expected state of the of the respective conflicted CB. That is, the processing device 402 generates an automatic command 140 to clear all identified conflicts. The first electronic device sends the command to the CBIC of the remote power distribution system 106, which actuates the respective CB to switch the OPEN/CLOSED position from the current state to the expected state. In other embodiments, as shown at block 520, the processing device 402 performs an action that can include outputting a user interface (such as GUI 300 of FIG. 3) capable of receiving user input indicating the user's desired selection to either (but not both): clear all conflicts identified; or clear a subset of conflicts identified.

At block 520, the user input can be received via an input device of the first electronic device (such as a keyboard, mouse, or touchscreen of the laptop computer of FIG. 1), and in response to receiving the user input, the first electronic device generates the command to change the current state of the CB. When the user's desired selection is to clear all conflicts identified, the user input includes a single selection (illustrated as “one-click”) to change the current state of every conflicted CB (namely, every respective CB associated with a conflict) to match the expected state of the of the conflicted CB, and the method 500 proceeds to block 522. Alternatively, when the user's desired selection is to clear a subset of conflicts identified, the user input includes selection (illustrated as “one-by-one”) of one or more conflicted CBs, which form a subset of CBs associated with the subset of conflicts to be cleared, and the method 500 proceeds to block 524. In a case in which the aircraft's data bus 104 allows bidirectional communication and allows the electronic device 102 of FIG. 1 to send a command 140, 142 to the remote power distribution system 106, and when the processing device 402 of the first electronic device represents the processor of the electronic device 102 of FIG. 1 (first embodiment) external to the aircraft's system, the command 140,142 is transmitted to an second electronic device (namely, the remote power distribution system 106) via the data bus 104. In other words, the application 415 (namely, CBCF app 130) in both the first embodiment (as shown in FIG. 1) and second embodiment (as shown in FIG. 2) of this disclosure enable conflicts to be cleared and without manual inputs.

At block 522, after the processing device 402 of the first electronic device has received the user input that includes a “one-click” single selection (for example, click on “FIX ALL” button) to correct all of the conflicts identified among the set of CBs, and in response to the received single selection, generates and sends a corresponding user-interactive command 142 to the CBIC of the remote power distribution system 106, 206. In response to receiving the command corresponding to the click on “FIX ALL” button, the remote power distribution system 106 actuates every conflicted CBs to switch the OPEN/CLOSED position from the current state to the expected state, respectively. The OPEN/CLOSED position of the conflicted CBs can be switched concurrently, sequentially one-by-one-, or sequentially group-by-group of multiple conflicted CBs that are switched concurrently. The method 500 the method 500 returns to block 504 to update the status information 120, at which stage the current state of the all previously conflicted CB matches the OATP table that contains the corresponding expected state, and all CBs among the set of CBs are ready for testing. Subsequently the method 500 ends 526 for the entire set of CBs.

At block 524, the processing device 402 of the first electronic device has received the user input that includes the one-by-one selection of a subset of conflicted CBs to be cleared. In response to the received selections of the subset of conflicted CBs, the processing device 402 of the first electronic device generates a corresponding command, namely, generating the user-interactive command 142 to change the current state of each conflicted CB within the selected subset to the expected state, respectively. Depending on the system architecture, the command can include multiple commands that switch multiple conflicted CBS, respectively, or can include a common command that switches multiple conflicted CBS sequentially (such as one after another). As an example, the CBIC tool 250 displays, on the flight deck 112, a user interface (for example, GUI 300 of FIG. 3) that receives the one-by-one selection from the user, generates a command 142 associated with the selected subset of conflicted CBs to be cleared, and transmits the command to a circuit breaker indication and control system of the aircraft.

In response to the CBIC receiving the command corresponding to the one-by-one selection, the remote power distribution system 106 actuates the respective conflicted CB to switch the OPEN/CLOSED position from the current state to the expected state. The method 500 returns to block 504 to update the status information 120.

When the method 500 returns to block 504, the remote power distribution system 106 updates the status information 120 based on the changed state of the previously-conflicted, now conflict-free CBs. Subsequently, at block 510, when the processing device 402 of the first electronic device determines the conflict check is completed and the identified conflicts are cleared for the entire set of CBs, the method ends 526. Alternatively, if it is determined that the conflict check is not completed for any remaining CBs among the set of CBs, or if the identified conflicts are not yet cleared for the entire set of CBs, the procedures of block 508 repeat to conflict check and clear any identified conflict associated with a remaining CB.

This disclosure is not limited to commands 140, 142 generated by the first electronic device (such as 102 of FIG. 1). In some embodiments, the user input can be received via an input device of an external second electronic device, such as a keypad 116 or other an input device associated with the flight deck display 112. The in response to receiving the user input to change the current state to match the expected state of the respective CB, the keypad 116 generates the command and transmits the command to the remote power distribution system 106. In response to receiving the command from the keypad 116, the remote power distribution system 106 actuates the respective CB to switch the OPEN/CLOSED position from the current state to the expected state.

It may be advantageous to set forth definitions of certain words and phrases used throughout this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
receiving, by a first electronic device via a data bus, status information associated with a set of circuit breakers (CBs) of an aircraft, the status information in a first data format and including a CB identifier and a current state of each circuit breaker (CB) among the set of CBs;
obtaining, by the first electronic device, a database that includes on aircraft test procedure (OATP) CB tables in a second data format and including the CB identifier and an expected state of each CB among the set of CBs;
translating the status information from the first data format to the second data format, thereby generating a translated current state of each CB among the set of CBs; and
for each respective CB among the set of CBs, determining whether the translated current state and the expected state conflict and in response to identifying a conflict between the expected state and the translated current state, generating a command to change the current state of the respective CB.

2. The method of claim 1, wherein generating the command to change the current state of the respective CB further comprises:
automatically changing the current state of the respective CB to match the expected state of the of the respective CB.

3. The method of claim 1, wherein generating the command to change the current state of the respective CB further comprises:
receiving user input via a user interface to change the current state of the respective CB to match the expected state of the of the respective CB.

4. The method of claim 3, wherein the user input includes a one-click selection to correct all of the conflicts identified among the set of CBs; and
the method further comprises generating the command to change the current state of each conflicted CB for which the conflict was identified between the expected state and the translated current state.

5. The method of claim 3, wherein the user input includes a one-by-one selection to correct the conflict identified between the expected state and the translated current state of a conflicted CB selected by the user input; and
the method further comprises generating the command to change the current state of the selected conflicted CB for which the conflict was identified.

6. The method of claim 1, further comprising:
connecting the first electronic device to a power distribution system of the aircraft via the data bus, wherein the power distribution system is connected to the set of CBs and generates the status information;
receiving the status information from the power distribution system connected to the data bus;
obtaining the database by retrieving the database from a memory of the first electronic device; and
transmitting the command to one or more conflicted CBs, among the set of CBs, for which the conflict was identified between the expected state and the translated current state.

7. The method of claim 1, wherein:
the first electronic device includes a power distribution system of the aircraft;
obtaining the database further comprises retrieving the database from an onboard maintenance server (OMS) of the aircraft; and
transmitting the command to a circuit breaker indication and control system of the aircraft.

8. The method of claim 1, wherein:
the first data format includes an ARINC data format specified by Airlines Electronic Engineering Committee (AEEC); and
the second data format includes a human-readable data format.

9. An electronic device comprising:
a processor configured to:
receive, via a data bus, status information associated with a set of circuit breakers (CBs) of an aircraft, the status information in a first data format and including a CB identifier and a current state of each circuit breaker (CB) among the set of CBs;
obtain a database that includes on aircraft test procedure (OATP) CB tables in a second data format and including the CB identifier and an expected state of each CB among the set of CBs;
translate the status information from the first data format to the second data format, thereby generating a translated current state of each CB among the set of CBs; and
for each respective CB among the set of CBs, determine whether the translated current state and the expected state conflict and in response to identifying a conflict between the expected state and the translated current state, generating a command to change the current state of the respective CB.

10. The electronic device of claim 9, wherein to generate the command to change the current state of the respective CB, the processor is further configured to:
automatically change the current state of the respective CB to match the expected state of the of the respective CB.

11. The electronic device of claim 9, wherein to generate the command to change the current state of the respective CB, the processor is further configured to:
receive user input via a user interface to change the current state of the respective CB to match the expected state of the of the respective CB.

12. The electronic device of claim 11, wherein:
the user input includes a one-click selection to correct all of the conflicts identified among the set of CBs; and
the processor is further configured to generate the command to change the current state of each conflicted CB for which the conflict was identified between the expected state and the translated current state.

13. The electronic device of claim 11, wherein the user input includes a one-by-one selection to correct the conflict identified between the expected state and the translated current state of a conflicted CB selected by the user input; and
the processor is further configured to generate the command to change the current state of the selected conflicted CB for which the conflict was identified.

14. The electronic device of claim 9, the processor is further configured to:
connect the electronic device to a power distribution system of the aircraft via the data bus, wherein the power distribution system is connected to the set of CBs and generates the status information;
receive the status information from the power distribution system connected to the data bus;
obtain the database by retrieving the database from a memory of the electronic device; and
transmit the command to one or more conflicted CBs, among the set of CBs, for which the conflict was identified between the expected state and the translated current state.

15. The electronic device of claim 9, further comprising a power distribution system of the aircraft,
wherein:
to obtain the database, the processor is further configured to retrieve the database from an onboard maintenance server (OMS) of the aircraft; and
the processor is further configured to transmit the command to a circuit breaker indication and control system of the aircraft.

16. The electronic device of claim 9, wherein:
the first data format includes an ARINC data format specified by Airlines Electronic Engineering Committee (AEEC); and
the second data format includes a human-readable data format.

17. A non-transitory, computer readable medium embodying a computer program, the computer program comprising program code that, when executed by a processor of an electronic device, causes the electronic device to:
receive, via a data bus, status information associated with a set of circuit breakers (CBs) of an aircraft, the status information in a first data format and including a CB identifier and a current state of each circuit breaker (CB) among the set of CBs;
obtain a database that includes on aircraft test procedure (OATP) CB tables in a second data format and including the CB identifier and an expected state of each CB among the set of CBs;
translate the status information from the first data format to the second data format, thereby generating a translated current state of each CB among the set of CBs; and
for each respective CB among the set of CBs, determine whether the translated current state and the expected state conflict and in response to identifying a conflict between the expected state and the translated current state, generating a command to change the current state of the respective CB.

18. The non-transitory computer readable medium of claim 17, wherein the program code that, when executed, causes the electronic device to generate the command to change the current state of the respective CB, further comprises program code that, when executed, causes the electronic device to:
receive user input via a user interface to change the current state of the respective CB to match the expected state of the of the respective CB.

19. The non-transitory computer readable medium of claim 17, wherein the computer program further comprises program code that, when executed, causes the electronic device to:
connect the electronic device to a power distribution system of the aircraft via the data bus, wherein the power distribution system is connected to the set of CBs and generates the status information;
receive the status information from the power distribution system connected to the data bus;
obtain the database by retrieving the database from a memory of the electronic device; and
transmit the command to one or more conflicted CBs, among the set of CBs, for which the conflict was identified between the expected state and the translated current state.

20. The non-transitory computer readable medium of claim 17, wherein:
the electronic device includes a power distribution system (PDS) of the aircraft; and
the computer program further comprises program code that, when executed, causes the PDS to:
obtain the database further comprises retrieving the database from an onboard maintenance server (OMS) of the aircraft; and
transmit the command to a circuit breaker indication and control system of the aircraft.
